(19) United States
(12) Patent Application Publication
(10) Pub. No.: US 2020/0269820 A1
(43) Pub. Date: Aug. 27, 2020

(54) CAR BODY REPAIR SYSTEM AND METHOD THEREOF

(71) Applicant: National Taiwan University of Science and Technology, Taipei (TW)

(72) Inventor: Chyi-Yeu Lin, Taipei (TW)

(73) Assignee: National Taiwan University of Science and Technology, Taipei (TW)

(21) Appl. No.: 16/507,048

(22) Filed: Jul. 10, 2019

(30) Foreign Application Priority Data
Feb. 26, 2019 (TW) 108106395

(51) Int. Cl. B60S 5/00; G05B 19/4099

(52) U.S. Cl. CPC B60S 5/00; G05B 2219/32226; G05B 2219/35012; G05B 19/4099

(57) ABSTRACT

A car body repair system and a method thereof are provided. The system includes a scan apparatus, a processor and an adjustment mechanism. The scan apparatus scan a car body to obtain current surface curve information related to a deformed three-dimension surface of the car body that is damaged. The processor obtains the current surface curve information and initial surface curve information related to an original three-dimension surface of the car body that has not been damaged. The processor compares the current surface curve information and the initial surface curve information to obtain deformation information. The adjustment mechanism adjusts the surface of the car body according to the deformation information to recover the car body to an initial state corresponding to the initial surface curve information. Accordingly, the repair efficiency is improved, and a high standard degree of repair is achieved.

### CROSS-REFERENCE TO RELATED APPLICATION

This application claims the priority benefit of Taiwan application serial no. 108106395, filed on Feb. 26, 2019. The entirety of the above-mentioned patent application is hereby incorporated by reference herein and made a part of this specification.

### BACKGROUND

### Technical Field

The invention relates to a vehicle maintenance technology, and particularly relates to a car body repair system and a method thereof.

### Description of Related Art

Automobile is one of the most commonly used means of transportation for modern people, due to its comfort, safety and high mobility, most families or companies own cars. Inevitably, cars may encounter accidents, which may result in damage to car bodies. General car body repair operations usually include procedures such as sheet metal, paint varnish, etc., to restore the appearance of the car body. The existing car body repair operations are usually performed manually, and two following situations are usually encountered. The first situation is a high degree of recovery (for example, similar to an undamaged condition) but slow repair. The second situation is quick repair but a low degree of recovery (for example, having a large difference from the undamaged condition). The manual repair usually fails to achieve both high degree of recovery and high efficiency at the same time. Therefore, the existing vehicle maintenance technology still needs to be improved.

### SUMMARY

The invention is directed to a car body repair system and a method thereof, which are adapted to repair a surface shape of a car body in a fully automatic manner.

The invention provides a car body repair system, including a scan apparatus, a processor and an adjustment mechanism. The scan apparatus is configured to scan a car body to obtain current surface curve information, wherein the current surface curve information is related to a deformed three-dimensional surface shape of the car body that is damaged. The processor is coupled to the scan apparatus, and is configured to obtain the current surface curve information and initial surface curve information of the car body. The initial surface curve information is related to original three-dimensional surface shape of the car body that has not been damaged. The processor compares the current surface curve information and the initial surface curve information to obtain deformation information between the initial surface curve information and the current surface curve information. The adjustment mechanism is coupled to the processor, and is configured to adjust a surface shape of the car body according to the deformation information, so as to recover the car body to an initial state corresponding to the initial surface curve information.

In an embodiment of the invention, the deformation information includes deformed areas on the car body, and a variation amount of at least one adjusting point in the deformed areas. The adjustment mechanism adjusts the surface shape of each of the deformed areas on the car body according to the variation amount of the adjusting points, so as to reduce the variation amount of the adjusting points.

In an embodiment of the invention, the adjustment mechanism performs a pulling out operation or a pushing back operation on each of the adjusting points.

In an embodiment of the invention, the processor determines undeformed areas relative to a symmetric plane according to deformed areas corresponding to the current surface curve information. The processor scans the undeformed areas through the scan apparatus, and the processor performs reflecting conversion on a scanning result of the undeformed areas and serves the reflected result as the initial surface curve information.

In an embodiment of the invention, the initial surface curve information is derived from a Computer Aided Design (CAD) model or a point cloud model of the car body.

In an embodiment of the invention, the processor executes precision alignment on the initial surface curve information and the current surface curve information to determine actual positions of deformed areas in the deformation information.

In an embodiment of the invention, the adjustment mechanism includes a multi-degree of freedom mechanism or a multi-axis robot arm.

In an embodiment of the invention, the car body repair system further includes a symmetric moving mechanism. The symmetric moving mechanism is coupled to the processor and the scan apparatus, and is controlled by the processor to drive the scan apparatus. The symmetric moving mechanism moves the scan apparatus to a corresponding position of the car body according to deformed areas corresponding to the current surface curve information.

In an embodiment of the invention, the symmetric moving mechanism includes an alignment device. The alignment device determines a post-movement position of the scan apparatus according to an image including the car body obtained by the scan apparatus, such that the post-movement of the scan apparatus and the deformed areas are symmetric relative to a central line of the car body.

In an embodiment of the invention, in response to the adjustment mechanism completing an initial adjustment operation on the car body, the scan apparatus again scans the car body to obtain subsequent surface curve information, and the processor determines an adjusting tool of the adjustment mechanism and fine-tuning information according to the subsequent surface curve information.

On the other hand, an embodiment of the invention provides a car body repair method including following steps: scanning a car body to obtain current surface curve information, wherein the current surface curve information is related to a deformed three-dimensional surface shape of the car body that is damaged; obtaining initial surface curve information of the car body, wherein the initial surface curve information is related to original three-dimensional surface shape of the car body that has not been damaged; comparing the current surface curve information and the initial surface curve information to obtain deformation information between the initial surface curve information and the current surface curve information; and adjusting a three-dimensional surface shape of the car body according to the deformation information, so as to recover the car body to an initial state corresponding to the initial surface curve information.

In an embodiment of the invention, the deformation information includes deformed areas on the car body, and a variation amount of at least one adjusting point in the deformed areas, and the step of adjusting the surface shape of the car body according to the deformation information includes: adjusting the surface shape of each of the deformed areas on the car body according to the variation amount of the adjusting points, so as to reduce the variation amount of the adjusting points.

In an embodiment of the invention, the step of adjusting the surface shape of each deformed area on the car body according to the variation amount of the adjusting points includes: performing a pulling out operation or a pushing back operation on each of the adjusting points.

In an embodiment of the invention, the step of obtaining the initial surface curve information of the car body includes following steps: determining undeformed areas relative to a symmetric plane according to deformed areas corresponding to the current surface curve information; scanning the undeformed areas; and performing reflecting conversion on a scanning result of the undeformed areas and serving the reflected result as the initial surface curve information.

In an embodiment of the invention, the initial surface curve information is derived from a Computer Aided Design (CAD) model or a point cloud model of the car body.

In an embodiment of the invention, the step of comparing the initial surface curve information and the current surface curve information includes: executing precision alignment on the initial surface curve information and the current surface curve information to determine actual positions of deformed areas in the deformation information.

In an embodiment of the invention, the step of adjusting the surface shape of the car body according to the deformation information includes: adjusting the surface shape of the car body through a multi-degree of freedom mechanism or a multi-axis robot arm.

In an embodiment of the invention, the step of obtaining the initial surface curve information of the car body includes: determining to perform a scanning operation at a corresponding position of the car body according to deformed areas corresponding to the current surface curve information.

In an embodiment of the invention, the step of determining to perform the scanning operation at the corresponding position of the car body according to the deformed areas corresponding to the current surface curve information includes: determining a position of the scanning operation according to an image including the car body, such that the position of the scanning operation and the deformed areas are symmetric relative to a central line of the car body.

In an embodiment of the invention, after the step of adjusting the surface shape of the car body according to the deformation information, the method further includes: in response to completion of an initial adjustment operation performed on the car body, again scanning the car body to obtain subsequent surface curve information; and determining an adjusting tool of the adjustment mechanism and fine-tuning information according to the subsequent surface curve information.

Based on the above description, the car body repair system and the method thereof provide automatic deficiency comparison, variation amount estimation, decision of tools and means for adjustment and repair, and adjustment of car body surface. In this way, man-made deficiencies are avoided, and efficiency of car body repair is greatly improved.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a device block diagram of a car body repair system according to an embodiment of the invention.

FIG. 2 is a schematic diagram of car scanning according to an embodiment of the invention.

FIG. 3 is a flowchart illustrating a car body repair method according to an embodiment of the invention.

FIG. 4A is a schematic diagram of an example of current surface curve information.

FIGS. 4B and 4C are schematic diagrams of an example of initial surface curve information.

FIGS. 5A and 5B are schematic diagrams of car symmetrical scanning according to an embodiment of the invention.

FIGS. 6A and 6B are schematic diagrams of an example of precision alignment and imprecision alignment.

FIG. 7 is a schematic diagram of an example of adjusting points in a deformed area DA.

### DESCRIPTION OF THE EMBODIMENTS

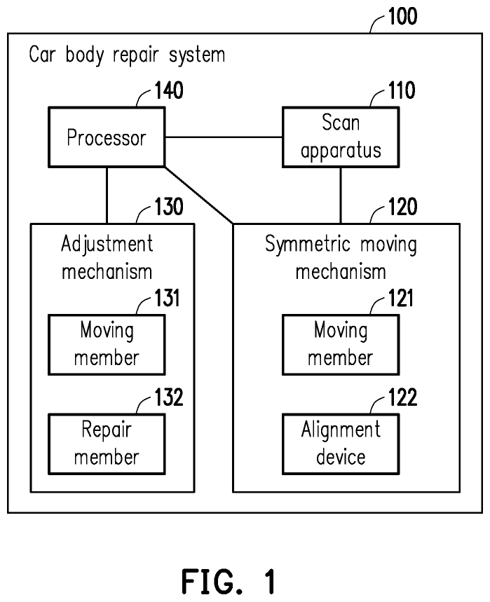

FIG. 1 is a device block diagram of a car body repair system 100 according to an embodiment of the invention. Referring to FIG. 1, the car body repair system 100 at least includes but is not limited to a scan apparatus 110, a symmetric moving mechanism 120, an adjustment mechanism 130 and a processor 140.

The scan apparatus 110 may be an image capturing device such as a two-dimensional (2D) or a three-dimensional (3D) camera, a video camera, a structured light module, etc. (including an image sensor such as a Charge Coupled Device (CCD), a Complementary Metal-Oxide-Semiconductor (CMOS), etc., a lens, etc.). The scan apparatus 110 may also be a distance detector such as a radio radar, an optical radar, an infrared detector, etc. The scan apparatus 110 is used for capturing an image of an external object (for example, a car), or detect a relative distance/position of the external object.

The symmetric moving mechanism 120 at least includes but is not limited to a moving member 121. The moving member 121 may be a multi-axis robot arm, a multi-degree of freedom mechanism, a height adjusting platform, a slide rail, a rotary table, a screw rod, a motor, or a cylinder stator and other types of mechanical components that may drive a connecting element to move or rotate, or a combination thereof, so as to drive the connected scan apparatus 110 to lift/descend, move and/or rotate. In an embodiment, the symmetric moving mechanism 120 further includes an alignment device 122. The alignment device 122 is an image-based visual servo device, which at least includes an image processor (for example, a Central Processing Unit (CPU), a Graphic Processing Unit (GPU), a Micro Control Unit (MCU), or an Application-Specific Integrated Circuit (ASIC), etc.), and is adapted to control a motion (for example, moving, rotating, etc.) of the moving component 121 based on an image captured by the scan apparatus 110 or an additionally installed image capturing device, or position information (for example, a relative position, a relative distance, an orientation, etc.) detected by Light Detection and Ranging (Lidar), and detailed operation thereof is described in subsequent embodiment.

The adjustment mechanism 130 at least includes but is not limited to a moving member 131 and repair member 132. The moving member 121 may be a multi-axis robot arm, a multi-degree of freedom mechanism, a height adjusting platform, a slide rail, a rotary table, a screw rod, a motor, or a cylinder stator and other types of mechanical components that may drive a connecting element to move or rotate, or a combination thereof, so as to drive the repair member 132 to lift/descend, move and/or rotate. The repair member 132 is connected to the moving member 131, and the repair member 132 may be a pulling out tool, a putty tool, a welding tool, a grinding tool, a paint removing tool, or other sheet metal repair tool.

The processor 140 may be a CPU, a GPU, a MCU, an ASIC, a chip or other similar device or a combination of the aforementioned devices. In the embodiment, the processor 140 controls all of operations of the car body repair system 100. For example, the processor 140 controls the scan apparatus 100 to capture or obtain the position information. The processor 140 controls motions such as moving, rotating, clamping, pushing and pulling, etc., of the moving members 121 and/or 131.

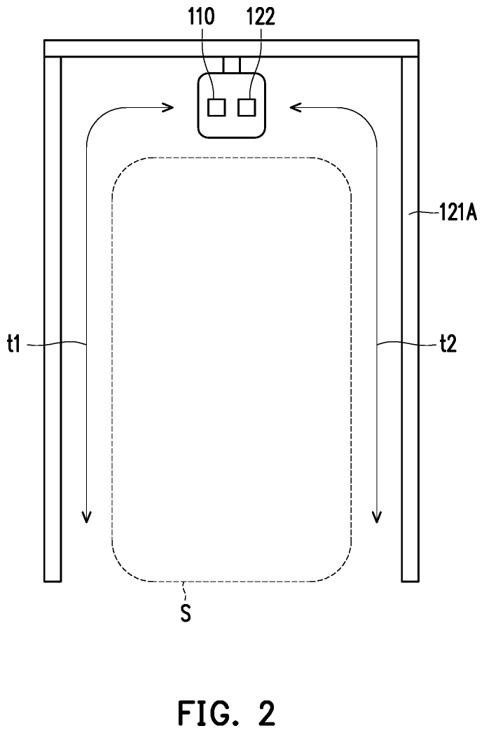

For example, FIG. 2 is a schematic diagram of car scanning according to an embodiment of the invention. Referring to FIG. 2, in the embodiment, the moving member 121 includes a slide rail 121A to drive the scan apparatus 110 and the alignment device 122 to move along a trajectory t1 or t2. A car to be detected may enter a space S to allow the scan apparatus 110 to perform scanning. The processor 140 drives the slide rail 121A to move the scan apparatus 110 and the alignment device 122 to a specific position, and controls the scan apparatus 110 to perform scanning, or controls the alignment device 122 to adjust a motion of the moving member 121.

In order to facilitate understanding of an operation flow of the embodiment of the invention, a plurality of embodiments is provided below to describe a flow of using the car body repair system 100 in detail. In the following description, the method of the invention is described with reference of various devices, elements and modules of the car body repair system 100. Various flows of the method may be adjusted according to an actual application, which are not limited by the invention.

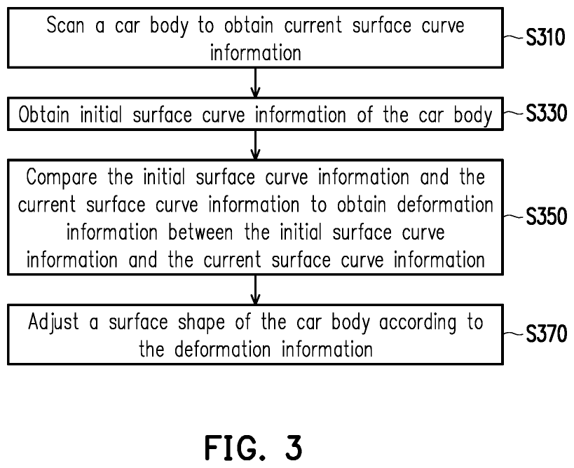

FIG. 3 is a flowchart illustrating a car body repair method according to an embodiment of the invention. Referring to FIG. 3, the processor 140 controls the moving member 121 to move the scan apparatus 110 to a predetermined point or to a plurality of specified positions step by step. When the scan apparatus 100 is located in the specified position, the processor 140 controls the scan apparatus 110 to scan the car body to obtain current surface curve information (step S310). In an embodiment, the scan apparatus 110 may surround the car body to scan all of a sheet metal appearance. In another embodiment, the scan apparatus 110 may only scan a specific part of the car body according to an instruction. It should be noted that the car body refers to a car body of a car. The current surface curve information is related to a deformed three-dimensional (3D) surface shape of the car body that is damaged (i.e. related to a damage deformation situation, or a depression distribution), and the processor 140 may create the current surface curve information according to a scanning result (for example, an image, position information, etc.) of the scan apparatus 110. The current surface curve information may be in form of a 3D model such as CAD, a point cloud, etc., and may be analyzed to obtain data of a deformed area, an undeformed area, a variation amount, etc. It should be noted that the surface shape referred to, in the embodiment of the invention, is related to a shape, size, and curvature of each small area on the surface of the car body.

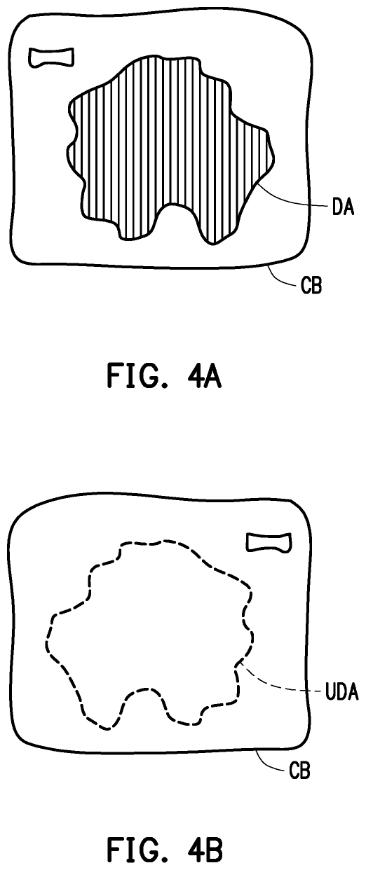

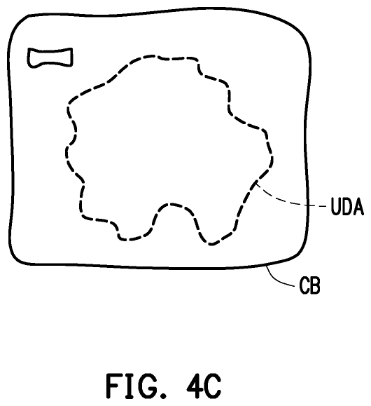

For example, the scan apparatus 110 is a 3D camera. After a certain car enters the space S shown in FIG. 2, the scan apparatus 110 photographs the car body along the trajectories t1 and t2. The processor 140 creates a 3D model of the car body according to the image captured by the scan apparatus 110. FIG. 4A is a schematic diagram of an example of the current surface curve information. Referring to FIG. 4A, the car body CB of the 3D model has a deformed area DA. The deformed area DA represents a region where the car body is depressed, protruded, or scratched.

The processor 140 obtains initial surface curve information of the car body (step S330). In the embodiment, the initial surface curve information is related to original 3D surface shape of the car body that has not been damaged. It should be noted that the method of obtaining the initial surface curve information is plural. In an embodiment, the processor 140 may obtain the initial surface curve information from the currently scanned car body.

To be specific, the processor 140 may determine one or multiple undeformed areas relative to a symmetric plane according to one or a plurality of deformed areas corresponding to the current surface curve information. The symmetric moving mechanism 120 moves the scan apparatus 110 to a corresponding position of the car body through the moving member 121 according to the deformed area corresponding to the current surface curve information. The processor 140 may preliminarily determine depressed, protruded or scratched portions of the car body from the initial surface curve information. For example, a certain area is discontinuous with its adjacent surface in radian, an undulating height thereof exceeds the predetermined value, a difference in metallic color is too large, etc. The processor 140 takes the depressed, protruded or scratched portions as deformed areas to determine positions of the deformed areas on the car body, and accordingly determines corresponding positions of the deformed areas on the symmetric plane of the car body. It should be noted that the symmetric plane refers to a symmetrical relationship relative to a central line of the car body (passing through center points of the head and tail of the car). For example, the deformed area is located to a left side of the car body, the corresponding position of the symmetric plane thereof is a specific position at the same level and same height on the right side of the car body. Then, the processor 140 moves the scan apparatus 110 to the aforementioned corresponding position through the moving member 121 (it is assumed that there are undeformed areas, i.e. there are no or only little micro-depressed, protruded or scratched portions). For example, the position of the scanning device 110 shown in FIG. 2 is taken as a reference point to control the scan apparatus 110 to move along the trajectory t2, and move the scan apparatus 110 by a specific distance (to move along the trajectory t1 by the specific distance will correspond to the position of the deformed area). The processor 140 controls the scan apparatus 110 to scan the undeformed areas, and the processor 140 performs reflecting conversion on a scanning result of the undeformed areas and serve the reflected result as the initial surface curve information. Since the unreformed areas have a symmetrical relationship with the deformed areas, after the reflecting conversion of 180 degrees, the 3D model with the undeformed areas may correspond to the same region of the deformed areas.

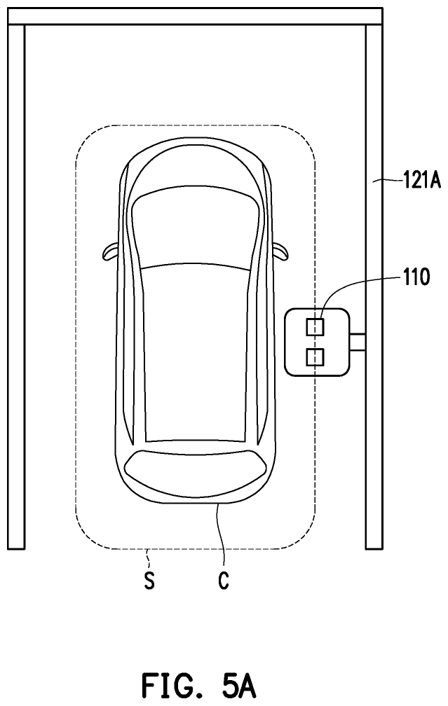

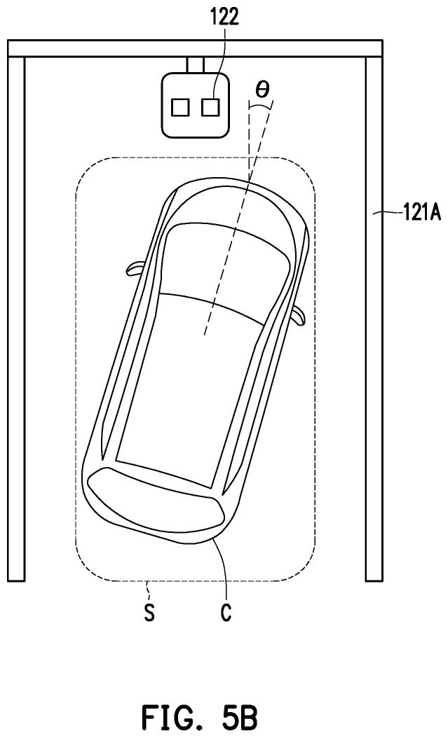

For example, taking FIG. 2 as an example, when the scan apparatus 110 scans a deformed area on the car body at a specific position on the trajectory t1, the processor 140 may move the scan apparatus 110 to another corresponding position on the trajectory t2 through the moving member 121 (shown in FIG. 5A), and again perform the scanning operation through the scan apparatus 110. FIGS. 4B and 4C are schematic diagrams of an example of the initial surface curve information. Referring to FIG. 4A and FIG. 4B, the original scanned data before being reflected is as that shown in FIG. 4B, an undeformed area UDA of FIG. 4B is opposite to a deformed area DA of FIG. 4A. Referring to FIG. 4C, after the reflecting conversion, the undeformed area UDA having the same direction with the deformed area DA is derived.

It should be noted that in some embodiments, in the step S310, if the scan apparatus 110 has scanned the whole car body or all of the sheet metal portion of the car body, the processor 140 may direct perform the reflecting conversion on the content of the area corresponding to the deformed area in the current surface curve information to serve as the initial surface curve information, and it is unnecessary to perform further scanning.

It should be noted that the aforementioned symmetric scanning procedure assumes that a parking direction of the car C is as shown in FIG. 5A whose central line is substantially aligned with a mid-perpendicular line of the slide rail 121A. In some situations, referring to FIG. 5B, the central line of the car C and the mid-perpendicular line of the slide rail 121A include an angle θ (which is greater than 0) there between. In this case, the alignment device 122 may determine the central line of the car C based on an image (including the car C) or position information obtained by an image capturing device, a radar or the scan apparatus 110, and the alignment device 122 may determine a post-movement position of the scan apparatus 110 (i.e., the position for which the scanning operation is directed, which can be symmetric with the deformed area relative to the central line of the car C) based on the direction of the current central line of the car C, so as to control movement of the position of the scan apparatus 110 to be symmetrical with respect to the current central line of the vehicle C (for example, based on a visual servo technology), and make the undeformed area in the initial surface curve information precisely corresponding to the deformed area in the current surface curve information.

In another embodiment of obtaining the initial surface curve information, the processor 140 obtain a Computer Aided Design (CAD) model, a point cloud model or other 3D curve figures of the car body through network download or input from a storage medium (for example, a hard drive, a hard disk, etc.). For example, a car manufacturer or others scan the car body to provide a model file for other users to download or use.

Then, the processor 140 compares the initial surface curve information and the current surface curve information to obtain deformation information between the initial surface curve information and the current surface curve information (step S350). In the embodiment, the deformation information, for example, includes deformed areas on the car body, and a variation amount of one or a plurality of adjusting points in the deformed areas. The processor 140 may confirm the corresponding areas after executing the precision alignment to the initial surface curve information and the current surface curve information.

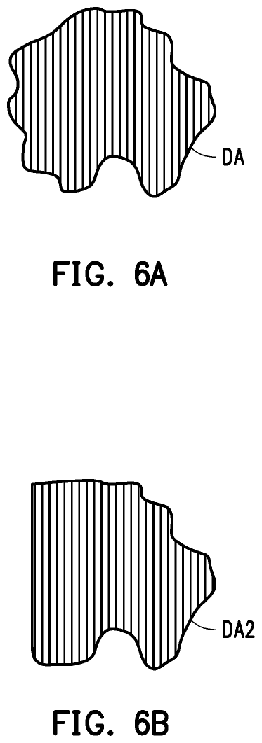

It should be noted that the precision alignment is one of the most important processes in the embodiment of the present invention, which not only affects a repair result, but also effectively compensates the deficiency of manual work. FIGS. 6A and 6B are schematic diagrams of an example of precision alignment and imprecision alignment. Referring to FIG. 6A, it is assumed that FIG. 6A illustrates the deformed area DA obtained after the precision alignment of FIG. 4A and FIG. 4C. Referring to FIG. 6B, in case of the imprecision alignment, some areas may be misjudged, so that the deformed area DA2 is different from the deformed area DA of FIG. 6A in shape. If repair is performed based on the deformed area DA2 of FIG. 6B, the car body cannot be completely restored to the shape before the damage.

After the precision alignment of the initial surface curve information and the current surface curve information, the processor 140 may confirm a variation amount such as a magnitude, a shape, a depth, etc., of the deformed area and an actual position thereof. The variation amount refers to a difference between the deformed area and the corresponding undeformed area. The processor 140 may determine a repair method and tools for subsequent repair based on the variation amount on the deformed area. If the sheet metal of the car body needs to be pulled out or pushed back, the processor 140 further determines adjusting points requiring the pulling out or pushing back operation and the variation amount of each of the adjusting points. It should be noted that the precision alignment refers to that a difference in position between the deformed area and the corresponding undeformed area is almost zero.

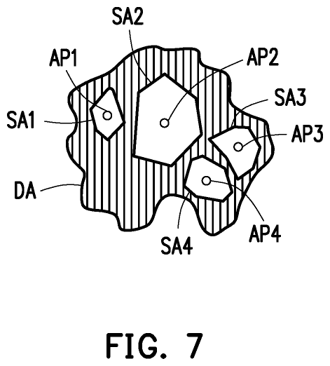

For example, FIG. 7 is a schematic diagram of an example of adjusting points AP1-AP4 in the deformed area DA. Referring to FIG. 7, in the deformed area DA, each of the adjusting points AP1-AP4 is a position required to be further pulled out. After the pulling out operation of each of the adjusting points AP1-AP4, adjusting areas SA1-SA4 influenced by the adjusting points AP1-AP4 will approach corresponding undeformed areas (for example, the undeformed area UDA shown in FIG. 4C) along with decrease of the corresponding variation amount.

It should be noted that there are many types of the repair member 132 and its vehicle surface repair methods (for example, putty sanding, welding, grinding, etc.), and the user may adjust the content of the deformation information according to an actual requirement. For example, areas that are non-overlapped with the adjusting areas SA1-SA4 in the deformed area DA of FIG. 7 may be repaired through primer filling and grinding operations.

The processor 140 then adjusts a surface shape of the car body through the adjustment mechanism 130 according to the deformation information (step S370), so as to recover the car body to an initial state corresponding to the initial surface curve information. In an embodiment, the adjustment mechanism 130 adjusts the surface shape of each deformed area on the car body according to the variation amount of the adjusting points (for example, a pulling out amount, a pushing back amount, a thickness, a color, etc.), so as to decrease or even eliminate the variation amounts of the adjusting points. Taking FIG. 6 as an example, the repair member 132 of the adjustment mechanism 130 is a pulling out tool, and the processor 140 may control the repair member 132 to move to the corresponding positions of the adjusting points AP1-AP4 through the moving member 131, such that the repair member 132 may perform a pulling out operation or a pushing back operation to each of the adjusting points AP1-AP4 according to the variation amount of each of the adjusting points AP1-AP4. Alternatively, if the variation amount is smaller than a threshold, and the repair member 132 is a putty tool and a grinding tool, the repair member 132 may fill primer to and grind the deformed area.

It should be noted that the tool and repair method of the repair member 132 are not limited to one, and the processor 140 may determine the tool and repair method according to the actual deformation information (or referred to variation information) of the deformed area.

Moreover, after the adjustment mechanism 130 completes an initial adjustment operation on the car body, the processor 140 may again scan the car body through the scan apparatus 110 to obtain subsequent surface curve information. The scan apparatus 110 may only scan the previous deformed area or again scan the whole car body. The subsequent surface curve information is a 3D surface shape of the car body after the initial repair. Then, the processor 140 determines whether further repair is required according to the subsequent surface curve information. For example, the processor 140 compares the subsequent surface curve information with the initial surface curve information, and determines whether a variation amount recorded by the deformation information there between is smaller than a threshold or equal to zero. If the further repair is required (for example, the variation amount is greater than zero or other threshold), the processor 140 may determine an adjusting tool (i.e. the type of the repair member 132) of the adjustment mechanism 130 and fine-tuning information (for example, the adjusting points, the variation amounts, etc.) according to the subsequent surface curve information, and again perform the adjusting operation.

In summary, according to the car body repair system and the method thereof of the invention, the car body is scanned to obtain the current surface curve information, and the current surface curve information is compared with the initial surface curve information related to none damage and deformation, and the deformed areas on the car body is directly repaired through the repair tool based on the deformation information between the current surface curve information and the initial surface curve information. Besides that the initial surface curve information may be obtained through download or input, the initial surface curve information may further be obtained by scanning the corresponding position of the symmetrical plane of the deformed area (i.e., symmetrical scanning) to execute reflecting conversion on. In this way, a fully automated car repair system is provided, where deficiencies of the car body are automatically analyzed to directly and automatically repair the deficiencies, so as to recover the car body to its original state, by which not only a high standard degree of repair is achieved, but also repair efficiency is effectively improved.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A car body repair system, comprising:
a scan apparatus, configured to scan a car body to obtain current surface curve information, wherein the current surface curve information is related to a deformed three-dimensional surface shape of the car body that is damaged;
a processor, coupled to the scan apparatus, and configured to obtain the current surface curve information and initial surface curve information of the car body, wherein the initial surface curve information is related to original three-dimensional surface shape of the car body that has not been damaged, the processor compares the current surface curve information and the initial surface curve information to obtain deformation information between the initial surface curve information and the current surface curve information; and
an adjustment mechanism, coupled to the processor, and configured to adjust a surface shape of the car body according to the deformation information, so as to recover the car body to an initial state corresponding to the initial surface curve information.

2. The car body repair system as claimed in claim 1, wherein the deformation information comprises at least one deformed area on the car body, and a variation amount of at least one adjusting point in the at least one deformed area, the adjustment mechanism adjusts the surface shape of each of the at least one deformed area on the car body according to the variation amount of the at least one adjusting point, so as to reduce the variation amount of the at least one adjusting point.

3. The car body repair system as claimed in claim 2, wherein the adjustment mechanism performs a pulling out operation or a pushing back operation on each of the at least one adjusting point.

4. The car body repair system as claimed in claim 1, wherein the processor determines at least one undeformed area relative to a symmetric plane according to at least one deformed area corresponding to the current surface curve information, the processor scans the at least one undeformed area through the scan apparatus, and the processor performs reflecting conversion on a scanning result of the at least one undeformed area and serves a reflected result as the initial surface curve information.

5. The car body repair system as claimed in claim 1, wherein the initial surface curve information is derived from a Computer Aided Design (CAD) model or a point cloud model of the car body.

6. The car body repair system as claimed in claim 1, wherein the processor executes precision alignment on the initial surface curve information and the current surface curve information to determine an actual position of at least one deformed area in the deformation information.

7. The car body repair system as claimed in claim 1, wherein the adjustment mechanism comprises a multi-degree of freedom mechanism or a multi-axis robot arm.

8. The car body repair system as claimed in claim 1, further comprising:
a symmetric moving mechanism, coupled to the processor and the scan apparatus, and controlled by the processor to drive the scan apparatus, wherein the symmetric moving mechanism moves the scan apparatus to a corresponding position of the car body according to at least one deformed area corresponding to the current surface curve information.

9. The car body repair system as claimed in claim 8, wherein the symmetric moving mechanism comprises:
an alignment device, determining a post-movement position of the scan apparatus according to an image comprising the car body obtained by the scan apparatus, such that the post-movement position of the scan apparatus and the at least one deformed area are symmetric relative to a central line of the car body.

10. The car body repair system as claimed in claim 1, wherein in response to the adjustment mechanism completing an initial adjustment operation on the car body, the scan apparatus again scans the car body to obtain subsequent surface curve information, and the processor determines an adjusting tool of the adjustment mechanism and fine-tuning information according to the subsequent surface curve information.

11. A car body repair method, comprising:
scanning a car body to obtain current surface curve information, wherein the current surface curve information is related to a deformed three-dimensional surface shape of the car body that is damaged;
obtaining initial surface curve information of the car body, wherein the initial surface curve information is related to original three-dimensional surface shape of the car body that has not been damaged;
comparing the initial surface curve information and the current surface curve information to obtain deformation information between the initial surface curve information and the current surface curve information; and
adjusting a surface shape of the car body according to the deformation information, so as to recover the car body to an initial state corresponding to the initial surface curve information.

12. The car body repair method as claimed in claim 11, wherein the deformation information comprises at least one deformed area on the car body, and a variation amount of at least one adjusting point in the at least one deformed area, and the step of adjusting the surface shape of the car body according to the deformation information comprises:
adjusting a surface shape of each of the at least one deformed area on the car body according to the variation amount of the at least one adjusting point, so as to reduce the variation amount of the at least one adjusting point.

13. The car body repair method as claimed in claim 12, wherein the step of adjusting the surface shape of each of the at least one deformed area on the car body according to the variation amount of the at least one adjusting point comprises:
performing a pulling out operation or a pushing back operation on each of the at least one adjusting point.

14. The car body repair method as claimed in claim 11, wherein the step of obtaining the initial surface curve information of the car body comprises:
determining at least one undeformed area relative to a symmetric plane according to at least one deformed area corresponding to the current surface curve information;
scanning the at least one undeformed area; and
performing reflecting conversion on a scanning result of the at least one undeformed area, and serving a reflected result as the initial surface curve information.

15. The car body repair method as claimed in claim 11, wherein the initial surface curve information is derived from a Computer Aided Design (CAD) model or a point cloud model of the car body.

16. The car body repair method as claimed in claim 11, wherein the step of comparing the initial surface curve information and the current surface curve information comprises:
executing precision alignment on the initial surface curve information and the current surface curve information to determine an actual position of at least one deformed area in the deformation information.

17. The car body repair method as claimed in claim 11, wherein the step of adjusting the surface shape of the car body according to the deformation information comprises:
adjusting the surface shape of the car body through a multi-degree of freedom mechanism or a multi-axis robot arm.

18. The car body repair method as claimed in claim 11, wherein the step of obtaining the initial surface curve information of the car body comprises:
determining to perform a scanning operation at a corresponding position of the car body according to at least one deformed area corresponding to the current surface curve information.

19. The car body repair method as claimed in claim 18, wherein the step of determining to perform the scanning operation at the corresponding position of the car body according to the at least one deformed area corresponding to the current surface curve information comprises:
determining a position of the scanning operation according to an image comprising the car body, such that the position of the scanning operation and the at least one deformed area are symmetric relative to a central line of the car body.

20. The car body repair method as claimed in claim 11, wherein after the step of adjusting the surface shape of the car body according to the deformation information, the method further comprises:
in response to completion of an initial adjustment operation performed on the car body, again scanning the car body to obtain subsequent surface curve information; and
determining an adjusting tool of the adjustment mechanism and fine-tuning information according to the subsequent surface curve information.
